(19) United States
(12) Patent Application Publication
(10) Pub. No.: US 2016/0256953 A1
(43) Pub. Date: Sep. 8, 2016

(54) METHOD AND SYSTEM FOR THE DETERMINATION OF VOLUMES OF VACUUM CHAMBERS AND EQUILIBRIUM TIMES FOR A VACCUUM SYSTEM

(71) Applicant: STC.UNM, Albuquerque, NM (US)

(72) Inventors: Zayd Leseman, Albuquerque, NM (US); Khawar Abbas, Portland, OR (US); Mirza Elahi, Albuquerque, NM (US); Arash Kheyraddini Mousavi, Albuquerque, NM (US); Edidson Lima, Albuqueque, NM (US); Stephen Moya, Albuquerque, NM (US)

(21) Appl. No.: 15/027,046

(22) PCT Filed: Oct. 3, 2014
(86) PCT No.: PCT/US2014/058949

§ 371 Date: Apr. 4, 2016

Related U.S. Application Data
(60) Provisional application No. 61/888,374, filed on Oct. 8, 2013.

(51) Int. Cl. B23K 10/00; G04F 13/06; G01F 17/00

(52) U.S. Cl. CPC B23K 10/006; G01F 17/00; G04F 13/06; B23K 10/003

(57) ABSTRACT

Provided is a method for determining a volume, at room temperature, of a first chamber having an unknown volume that is in fluid communication through a controllable valve with a second chamber having an unknown volume. The method can include measuring, by a pressure sensor coupled to one of the first chamber and the second chamber, a first equilibrium pressure of a gas that was introduced into the second chamber in both the first chamber and the second chamber after equilibrium is reached; measuring, by the pressure sensor, a second equilibrium pressure of the gas that was introduced into the second chamber in both the first chamber and the second chamber after equilibrium is reached, wherein the first chamber comprises an object with a known volume therein; and determining the volume of the first chamber based on the first equilibrium pressure and the second equilibrium pressure.

### CROSS-REFERENCE TO RELATED APPLICATIONS

This application claims the benefit of a related U.S. Provisional Application Ser. No. 61/888,374, filed on Oct. 8, 2013, which is incorporated by reference herein in its entirety.

### GOVERNMENT INTEREST

This invention was made with U.S. Government support under Grant No. DE-SC0004624 awarded by the Department of Energy. The U.S. Government has certain rights in the invention.

### FIELD

The present disclosure relates to pulsed vacuum system, and more particularly with method for determining volumes of chambers used in pulsed vacuum system and methods for modeling the behavior of components of pulsed vacuum chamber.

### BACKGROUND

Rekindled interest has developed in pulsed vacuum systems due to their use for Xenon Difluoride (XeF₂) etching systems and their usefulness in the fabrication of MEMS and nanostructures. Despite numerous applications of pulsed vacuum systems, little information is available in the prior art on their design considerations. The use of pulsed vacuum systems is widespread across various manufacturing and processing industries. They are used in numerous industries such as poultry meat and fruit processing/treatments, sterilization of medical equipment, manufacturing of hi-tech MicroElectroMechanical Systems (MEMS), and semiconductors devices. Despite being used for commercial applications since at least the 1960s not much information is available in the literature on the considerations for designing a pulsed vacuum system. Their more recent use for semiconductor and MEMS device manufacture has brought renewed attention to pulsed vacuum systems.

XeF₂ was first used to etch silicon in 19785. Etching with XeF₂ has many advantages over traditional silicon etching techniques such as high selectivity, fast etch rates, isotropic etching, spontaneous etching at room temperature, and has been shown to be useful in the fabrication of MEMS devices. Liquid etchants can cause MEMS failure through stiction and plasma etchants can damage them due to high energies and temperatures. Plasma etching processes are also limited in selectivity. The XeF₂ etching process removes these complications and helps lead to higher yields in MEMS production. High selectivity has been observed for many metals and masking materials, including Si₃N₄, SiC, SiO₅, W, Al, TiN, Cr, Au, SiO₂, and photoresists. XeF₂ can also be used to etch metals like molybdenum, titanium, and nickel. Although several custom pulsed XeF₂ systems have been developed in the past and some are also available commercially, the discussions have always been restricted to the etch characteristics and rate dependencies and not on the design characteristics of the system itself.

Hence there is a need for a new approach for mathematically modeling using design considerations of the pulsed vacuum system itself.

### SUMMARY

According to the present disclosure, a method for determining a volume, at room temperature, of a first chamber having an unknown volume that is in fluid communication through a controllable valve with a second chamber having an unknown volume is disclosed. The method can comprise measuring, by a pressure sensor coupled to one of the first chamber and the second chamber, a first equilibrium pressure of a gas that was introduced into the second chamber in both the first chamber and the second chamber after equilibrium is reached; measuring, by the pressure sensor, a second equilibrium pressure of the gas that was introduced into the second chamber in both the first chamber and the second chamber after equilibrium is reached, wherein the first chamber comprises an object with a known volume therein; determining, by a processor, the volume of the first chamber based on the first equilibrium pressure and the second equilibrium pressure.

In the method, wherein prior to the measuring the first equilibrium, the method further comprise reducing a pressure of the first chamber from a first initial pressure to a first intermediate pressure while the controllable valve is closed and the first chamber and the second chamber are isolated from each other.

The method can further comprise increasing a pressure of the second chamber from a second initial pressure to a second intermediate pressure by introduction of the gas, wherein the first intermediate pressure is much less than the second intermediate pressure while the controllable valve is closed.

The method can further comprise opening the controllable valve separating the first chamber and the second chamber such that the gas introduced into the second chamber is allowed to each equilibrium between the first chamber and the second chamber.

In the method, the first chamber is an expansion chamber and the second chamber is an etching chamber of a pulsed XeF₂ etching system.

In the method, the first chamber is an etching chamber and the second chamber is an expansion chamber of a pulsed XeF₂ etching system.

According to the present disclosure, a method for modeling a pulse duration that a sample is etched in a pulsed vacuum system having a pump that is in controllable fluid communication with a dump chamber this is in controllable fluid communication with an etching chamber that is in controllable fluid communication with an expansion chamber is disclosed. The method can comprise partitioning the pulsed vacuum system into a first subsystem comprising the pump, the dump chamber, and the etching chamber and a second subsystem comprising the etching chamber and the expansion chamber; separately modeling the first subsystem and the second subsystem using an energy balance technique; and determining, by a processor, the pulse duration to be used in the etching chamber based on the modeling.

The method can further comprise partitioning the first subsystem into a first sub-subsystem comprising the pump and the dump chamber and a second sub-subsystem comprising the dump chamber and the etching chamber and separately modeling the first sub-subsystem and the second sub-subsystem using the energy balance technique. The energy balance technique can comprise applying the Ideal Gas Law to each chamber of the pulsed vacuum system.

According to the present disclosure, a system for modeling a pulse duration that a sample is etched in a pulsed vacuum system having a pump that is in controllable fluid communication with a dump chamber this is in controllable fluid communication with an etching chamber that is in controllable fluid communication with an expansion chamber is disclosed. The system can comprise one or more memory devices storing instructions; and one or more processors coupled to the one or more memory devices and configured to execute the instructions, the one or more processors to: partition the pulsed vacuum system into a first subsystem comprising the pump, the dump chamber, and the etching chamber and a second subsystem comprising the etching chamber and the expansion chamber; separately model the first subsystem and the second subsystem using an energy balance technique; and determine the pulse duration to be used in the etching chamber based on the modeling.

The one or more processors can further execute the instructions to: partition the first subsystem into a first sub-subsystem comprising the pump and the dump chamber and a second sub-subsystem comprising the dump chamber and the etching chamber; and separately model the first sub-subsystem and the second sub-subsystem using the energy balance technique. The energy balance technique can comprise applying the Ideal Gas Law to each chamber of the pulsed vacuum system.

According to the present disclosure, a non-transitory computer-readable storage medium having instructions which, when executed on a processor, perform a method for modeling a pulse duration that a sample is etched in a pulsed vacuum system having a pump that is in controllable fluid communication with a dump chamber this is in controllable fluid communication with an etching chamber that is in controllable fluid communication with an expansion chamber is disclosed. The method can comprise partitioning the pulsed vacuum system into a first subsystem comprising the pump, the dump chamber, and the etching chamber and a second subsystem comprising the etching chamber and the expansion chamber; separately modeling the first subsystem and the second subsystem using an energy balance technique; and determining, by a processor, the pulse duration to be used in the etching chamber based on the modeling.

The non-transitory computer-readable storage medium can further comprise partitioning the first subsystem into a first sub-subsystem comprising the pump and the dump chamber and a second sub-subsystem comprising the dump chamber and the etching chamber; and separately modeling the first sub-subsystem and the second sub-subsystem using the energy balance technique. The energy balance technique can comprise applying the Ideal Gas Law to each chamber of the pulsed vacuum system.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF FIGURES

FIG. 1 shows an example schematic of a pulsed vacuum system, according to the present teachings.

FIG. 2a shows an example schematic representation of the system of two initially unknown volumes connected together via an isolating value and FIG. 2b shows the system presented in FIG. 2a, but with a solid block of known volume V₃, according to the present teachings.

FIG. 3 shows an example plot of volume versus the initial pressure in the expansion chamber, where the upper line is for the etching chamber V₁ and the lower line is for the expansion chamber V₂, according to the present teachings.

FIG. 4 shows an example schematic representation of a single gas pulse in a system etching chamber, according to the present teachings.

FIG. 5 shows a schematic representation of a system bifurcation into subsystems, according to the present teachings.

FIG. 6 shows an example comparison plot of the modeled rise and fall of the etching and expansion chambers with experimental data, according to the present teachings.

FIG. 7 shows an example schematic representation of the bifurcation of Subsystem 2 in FIG. 5, according to the present teachings.

FIG. 8 shows example scenarios with different relative time constants for Subsystem 2: a) τ₂ₐ<<τ_{2b}; b) τ₂ₐ>>τ_{2b}; c) τ₂ₐ˜τ_{2b}; d) displays the model and experimental for when the effective time constant is 300 msec, according to the present teachings.

FIG. 9 shows an example method for determining a volume of a chamber in a pulsed vacuum system, according to the present teachings.

FIG. 10 shows an example method for modeling a pulse duration that a sample is etched in a pulsed vacuum system, according to the present teachings.

FIG. 11 illustrates an example of a computing system, according to the present teachings.

### DESCRIPTION

Reference will now be made in detail to the present embodiments, examples of which are illustrated in the accompanying drawings. Wherever possible, the same reference numbers will be used throughout the drawings to refer to the same or like parts.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less that 10” can assume negative values, e.g.−1, −2, −3, −10, −20, −30, etc.

According to the present teachings, mathematical models and their experimental verification are presented for various design considerations of pulsed vacuum systems. Control of the chamber pressure and pulse duration is typically desired design consideration for processes involving pulsed vacuum systems. Allowing a known pressure and volume of gas to move between two chambers accurately controls chamber pressure. Pressure sensors can give the exact pressure; however, exact volumes are typically unknown and difficult to determine. Thus, provided herein is a method for accurate determination of chamber volume that comprises the introduction of a calibrated volume into a chamber. By varying chambers' volumes, configurations, pressures, and the conductances between the chambers, the pulse duration can be accurately controlled. Though the present disclosure is presented in the context of a pulsed XeF₂ etching system, the present disclosure can be used for a plurality of pulsed vacuum systems.

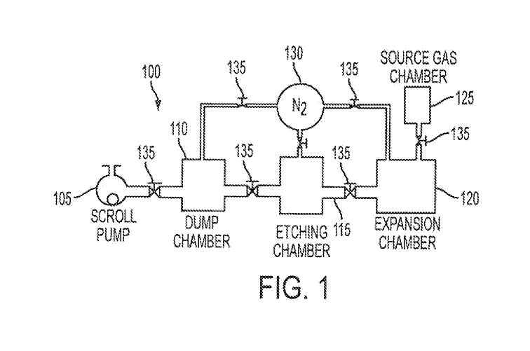

FIG. 1 shows an example simplified schematic of a pulsed vacuum system 100, according to the present teachings. Pulsed vacuum system 100 can be for used for pulsed XeF₂ etching and can comprises four stainless steel chambers 110, 115, 120, and 125 connected in series and isolated from each other via computer controlled pneumatic valves 135 and a scroll pump 105. XeF₂ is a white, crystalline chemical that sublimates at vapor pressures below 3.8 Torr. XeF₂ crystals are stored in the source chamber 125 and vacuum is pulled to obtain XeF₂ gas; alternatively the source chamber 125 is replaced by a gas bottle of anhydrous XeF₂ or any other chemical process gas (or liquid that evaporates at similar pressures) if required. The remaining three chambers namely: the etching chamber 115, the expansion chamber 120 and the dump chamber 110 can be all instrumented with the 0-10 Torr pressure sensors (not shown) that provide accurate pressure measurements and real time feedback for a custom written computer software to automatically control the etching processes by operating isolation valves 135. The expansion chamber 120 is installed between the source gas chamber 125 and the etching chamber 115 and allows a known pressure of XeF₂ to be metered into the etching chamber 115.

The etching chamber 115 is the main chamber of this system and the entire system 100 is built around controlling and maintaining the introduction and withdrawal of the charge gas from this chamber. Samples (not shown) to be etched are placed in the etching chamber 115. The lid (not shown) of the etching chamber 115 can be sealed with a Viton O-ring (not shown) and can be held closed by vacuum. The lid allows access into the etching chamber 115 for sample placement and removal. The etching chamber 115 also can allow for etch depth monitoring via clear glass view port in real time. The dump chamber 110 is a large volume kept under vacuum that enables rapid withdrawal of charge gas (and etch products) from the etching chamber 115. With the exception of the source gas chamber 125, all other chambers 110, 115, and 120 can be vented individually by the direct introduction of nitrogen gas. The source gas chamber 125 can be vented through the expansion chamber 120 when required. This prevents diluting the XeF₂ with nitrogen by accidental venting of the source gas chamber 125.

During pulsed etching, the expansion chamber 120 can be isolated from the source gas chamber 125 and the etching chamber 115 and the pressure of the expansion chamber 120 is lowered to a base pressure (approximately 10 mTorr for the scroll pump 105). The expansion chamber 120 can then be opened to the source gas chamber 125, and XeF₂ sublimates into the expansion chamber 120. The valve 135 to the source gas chamber 125 can be closed when the expansion chamber 120 reaches the desired pressure, and the etching chamber 115 can be brought to the base pressure of the system 100 and again isolated from the scroll pump 105. The valve 135 between the expansion chamber 120 and the etching chamber 115 can then be opened for a short period of time, allowing a change of gas to flow into the etching chamber 115 until it achieves the desired etching pressure. The valve 135 can then be closed and the system 100 waits for a user-defined etch pulse duration (normally ˜60 sec or longer) before the valve 135 between the etching chamber 115 and the dump chamber 110 is opened to remove or quickly ‘dump’ the gas charge into the dump chamber 110. The valve 135 between the scroll pump 105 and the dump chamber 110 can be kept opened. The cycle is iterated for a user-defined number of cycles known as pulses.

Accurate determination and calibration of chamber volumes is desired for the experimental verification of any mathematical formulation involving gases at known pressures in chambers with finite volumes. Most real life chambers are not exact rectangles or cylinders as normally depicted in the literature as schematic diagrams, they are shaped with ease of fabrication in mind to usually meet the spatial requirements. Also the existence of input and output ports, tubing lines, nooks, crevices and volumes occupied by the chucks or sample clamps makes the accurate determination of chamber volume by dimensional measurements difficult.

Addition of water or any other liquid into a vacuum based system is typically impractical. It may introduce contamination into the system, damage valves or electronics, and trapped gases in the liquid may introduce additional error. With this in mind, a method is provided herein to determine accurate chamber volumes, according to the present teachings. The method provided herein is traceable to the calibration standards of length and volume. Though used to calibrate the volume of the pulsed vacuum system, the method can be used to calibrate a plurality of vacuum systems.

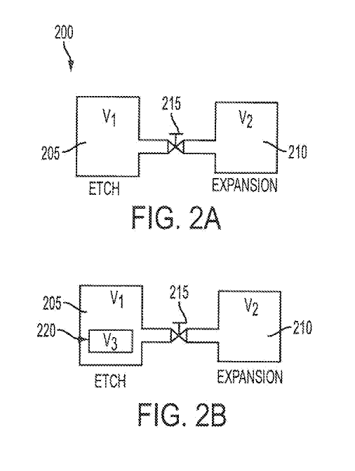

Consider a system 200 of two unknown volumes 205 and 210 connected to each other via a valve 215 that can isolate them from each other, as shown in FIG. 2a. For pulsed vacuum systems, such as one described above in FIG. 1, volume 1 (V₁) could represent the volume of the etching chamber 115, 205 and volume 2 (V₂) could represent the volume of the expansion chamber 120, 210. Using the above example system 100 of FIG. 1 and assuming that the system 100, 200 is at room temperature (T=300K) and the etching chamber 115, 205 has been pumped down to pump base pressure and the expansion chamber 120, 210 is filled with gas at some known pressure P₂ such that the pressure P₁<<P₂, then the following conditions will describe this state of the system.

State 1:

| | | | |
|---|---|---|---|
| P₁= 0; | V₁ = unknown; | n₁ = 0; | T₁ = 300 K; |
| P₂ = P₂ (known); | V₂ = unknown; | n₂ = n (unknown) | T₂ = 300 K; |

where P, V, n and T are the pressure, volume, number of moles of gas and gas temperature, respectively. A subscript of 1 indicates the etching chamber and 2 indicates the expansion chamber. The equation for the state of the system is given by the ideal gas law:

P₂V₂−nRT=0 (1)

where R is the ideal gas constant. Now assume that the valve 215 isolating the two systems is opened and gas is allowed to fill the etching chamber 115, 205 (V₁).

After the system 100, 200 has achieved equilibrium the new state of the system is:

State 2:

| | | | |
|---|---|---|---|
| P₁ = P_{f} (known); | V₁ = unknown; | n₁ = nV₁/(V₁ + V₂); | T₁ = 300 K; |
| P₂ = P_{f} (known); | V₂ = unknown; | n₂ = nV₂/(V₁ + V₂); | T₂ = 300 K; |

where P_{f} is the final pressure of the gas in both the chambers and is measured from the pressure gages attached to the chambers. This state of the system can be described by:

P_{f}(V₁+V₂)−nRT=0 (2)

From Eqs (1) and (2) it is clear that we have two equations and three unknowns (V₁, V₂ and n). In order to solve the system, another equation is required. This is achieved by adding a solid block of known volume (V₃) 220 to the etching chamber (V₁) 115, 205 and thereby reducing the volume of the etching chamber 115, 205 by V₃ (FIG. 2b). An alternative (not shown) is to add a known volume (additional chamber) to the system thus increasing the volume rather than reducing it. When the expansion chamber 120, 210 is filled with the same pressure P₂ as previously and the isolation valve 215 is opened the system 100, 200 attains a new equilibrium pressure P′_{f} and the state of the system now is:

State 3:

| | | | |
|---|---|---|---|
| P₁ = P′_{f} (known); | V₁ = unknown | n₁ = nV₁/(V₁ − V₃ + | T₁ = 300 K; |
| | | V₂); | |
| P₂ = P′_{f} (known); | V₂ = unknown; | n₂ = nV₂/(V₁ − V₃ + | T₂ = 300 K; |
| | | V₂); | |

In this state the system can now be described by:

P′_{f}(V₁−V₃+V₂)−nRT=0 (3)

Eqs. (1)-(3) can now be solved by forward elimination and backward substitution to obtain all the three unknowns

$$\begin{matrix}n = \frac{{V}_{3}}{RT ( \frac{1}{{P}_{f}} - \frac{1}{{P}_{f}^{′}} )} & ( 4 a ) \\ {V}_{2} = ( RT \text{/} {P}_{2} ) n & ( 4 b ) \\ {V}_{1} = {V}_{3} - {V}_{2} + ( RT \text{/} {P}_{f}^{′} ) n & ( 4 c )\end{matrix}$$

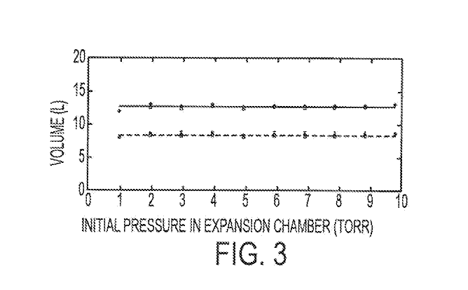

FIG. 3 shows a plot of volume versus the initial pressure in the expansion chamber 120,210, according to the present teachings. The data that falls on the upper line is for the etching chamber, V₁, 115, 205 and the lower line is for the expansion chamber, V₂, 120, 210. Note that there are 10 separate pressures at which data was taken and that there are two data points for each pressure around each horizontal line. Two data points are present around each because 2 different calibrated volumes were introduced into the etching chamber in order to test this method. Error bars for the data are smaller than the data itself. The horizontal lines in FIG. 3 are a fit through each set of 20 data points. The volume of the etching chamber 115, 205 is determined to be 12.8 L and that of the expansion chamber 120, 210 is 8.40 L.

The volume of other chambers can be found in a similar manner. In this way the volume of the dump chamber 110 and the volume of the source gas chamber 125 can be determined. Again, the length and volume standard are applied to V₃ and thus this method is traceable.

Accurate modeling and control of the pulse duration for a pulsed vacuum system is desired. In a pulsed gas system the gas is let into the process chamber (etching chamber 115 in this case) by opening the inlet isolation valve 135 until the chamber has reached a desired process pressure; at which point the valve 135 is closed and this pressure is maintained for a certain period of time (pulse duration). Finally, opening the outlet isolation valve 135 pumps the gas out. This process is repeated several times to obtain the desired number of pulses.

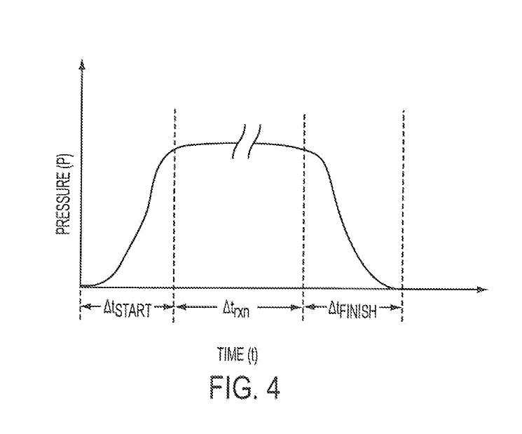

FIG. 4 schematically represents the pressure as a function of time for a pulsed vacuum system, according to the present teachings. For a pulsed XeF₂ etching system, a sample (not shown) placed in the etching chamber 115 begins etching as soon as the gas is let into the etching chamber 115, even before it has the reached the desired pressure. The etching continues until the last of the gas is evacuated from the etching chamber 115 long after the pressure of the etching chamber 115 has dropped down from the desired value. In order to control the etching process and determine etch rates under various conditions; it is desired that the samples are etched for a ‘known’ amount of time under ‘known’ conditions. This implies; having Δtᵣₓₙ>>Δtₛₜₐᵣₜ. and Δtᵣₓₙ>>Δt_{finish}. Even though Δtᵣₓₙ is user defined, both Δtₛₜₐᵣₜ and Δt_{finish} are dependent on the design of the overall system.

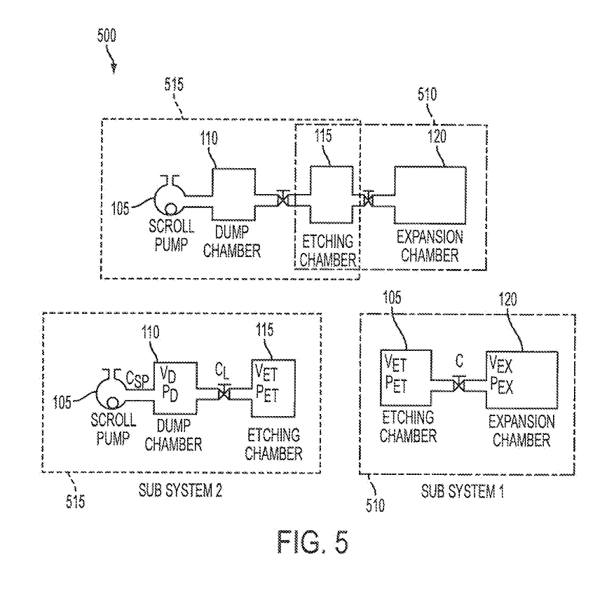

In order to formulate a mathematical model that is used to design these parameters, system 500 can be bifurcated into two subsystems 510 and 515 as shown in FIG. 5. Subsystem 1 510 is used to describe a set of conditions when the gas is let into the etching chamber 115 from the expansion chamber 120 whereas Subsystem 2 515 is used to describe a set of conditions when the gas is evacuated from the etching chamber 115. In other words, Subsystems 1 510 and 2 515 are used to model the beginning and the end of a single pulse, respectively.

Consider Subsystem 1 510 in FIG. 5. The expansion chamber 120 contains gas at some known pressure Pexp, whereas the etching chamber 115 is completely evacuated, Petch=0. The volume for both the chambers is known, for example, measured by the method provided above. The isolation valve 135 between the two chambers 115, 120 is then opened and gas is allowed to flow from the expansion chamber 120 into the etching chamber 115. Mathematically this system can be described as:

| | |
|---|---|
| for t < 0 | PₑₓₚVₑₓₚ = nRT |
| for t = 0 | Pₑₓₚ = Pᵢₙᵢₜᵢₐₗ |
| for t = ∞ | P_{∞}(V_{etch} + Vₑₓₚ) = nRT |

Realize that the Ideal Gas Law is an energy balance and then it can be stated that for all times, t between 0 and ∞

$$\begin{matrix}{P}_{etch} ( t ) {V}_{etch} + {P}_{exp} ( t ) {V}_{exp} = n RT & \\ {P}_{etch} ( t ) = \frac{n RT - {P}_{exp} ( t ) {V}_{exp}}{{V}_{etch}} & ( 5 ) \\ {P}_{exp} ( t ) = \frac{n RT - {P}_{etch} ( t ) {V}_{etch}}{{V}_{exp}} & ( 6 )\end{matrix}$$

From continuity one can represent the flow between the closed volumes as:

$${V}_{exp} \frac{d {P}_{exp}}{d t} + C ( {P}_{exp} - {P}_{etch} ) = {V}_{etch} \frac{d {P}_{etch}}{d t} \qquad ( 7 )$$

where C is the conductance of the tubing connecting the etching chamber 115 to the expansion chamber 120. Substituting Eq. (5) into (7) to solve for Pₑₓₚ(t):

$$\frac{d {P}_{exp}}{d t} = \frac{- C}{2} ( \frac{1}{{V}_{exp}} + \frac{1}{{V}_{etch}} ) {P}_{exp} + \frac{CnRT}{2 {V}_{exp} {V}_{etch}}$$

$$where r = \frac{- c}{2} ( \frac{1}{{V}_{exp}} + \frac{1}{{V}_{etcj}} ) and k = \frac{CnRT}{2 {V}_{exp} {V}_{etch}}$$

$$or$$

$$\frac{d {P}_{exp}}{d t} = - r {P}_{exp} + k$$

The differential equation above has the solution of the form

$${P}_{exp} ( t ) = - \frac{k}{r} + {Ae}^{n}$$

The initial condition for expansion chamber 120 is Pₑₓₚ(t=0)=Pᵢₙᵢₜᵢₐₗ leading to:

$${P}_{exp} ( t ) = \frac{n RT}{( {V}_{exp} + {V}_{etch} )} + ( {P}_{initial} - \frac{n RT}{( {V}_{exp} + {V}_{etch} )} ) {e}^{\frac{C}{2} ( \frac{1}{{V}_{exp}} + \frac{1}{{V}_{etch}} )} \qquad ( 8 )$$

Similarly, the solution for P_{etch}(t) can be found by substituting Eqn. (6) into (7) and applying the initial condition that P_{etch}(t=0)=0:

$${P}_{etch} ( t ) = \frac{n RT}{( {V}_{exp} + {V}_{etch} )} ( 1 - {e}^{\frac{C}{2} ( \frac{1}{{V}_{exp}} + \frac{1}{{V}_{etch}} ) t} ) \qquad ( 9 )$$

From Eqs. (8) and (9) the time constant for Subsystem 1 510 is:

$$τ = \frac{2}{C ( \frac{1}{{V}_{exp}} + \frac{1}{{V}_{etch}} )} \qquad ( 10 )$$

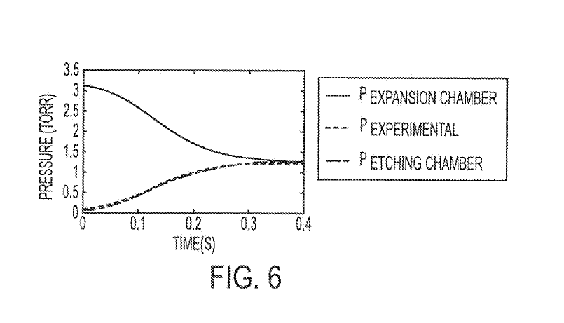

Eqn. 10 shows that the time constant for the system is a function of both the system conductance and the chamber volume. By judiciously choosing the system's volumes and conductances, the time constant for the pulse rise is designed. FIG. 6 compares the modeled rise and fall of the etching and expansion chambers with the experimental results from the actual system. The time constant for the pulse rise was 0.17 sec. Note that common etching times, Δtᵣₓₙ, in the literature commonly range between 30-60 sec. Making τ<0.3 sec ensures that for common conditions etching chamber's pressure rise accounts for less than 1% of the overall etching time and therefore accounts for a negligible portion of the actual etching time.

Just as it is desired to ensure that Δtₛₜₐᵣₜ is negligible in comparison to Δtᵣₓₙ it is also desired to ensure that Δt_{finish} is negligible as well. One solution is to use a pump with a large enough pumping rate to remove the gases in the etching chamber 115. However, pumps with relatively large pumping rates are considerably more expensive than those with lowering pumping rates if they are even available at all. Thus one solution to this issue is to connect a tank (not shown) between a pump and the etching chamber 115 that is always open to vacuum. This reservoir tank can be used to quickly ‘dump’ the pressure to a lower pressure to stop the reaction occurring in the etching chamber 115 and more quickly move the etching chamber 115 to the base pressure of the system.

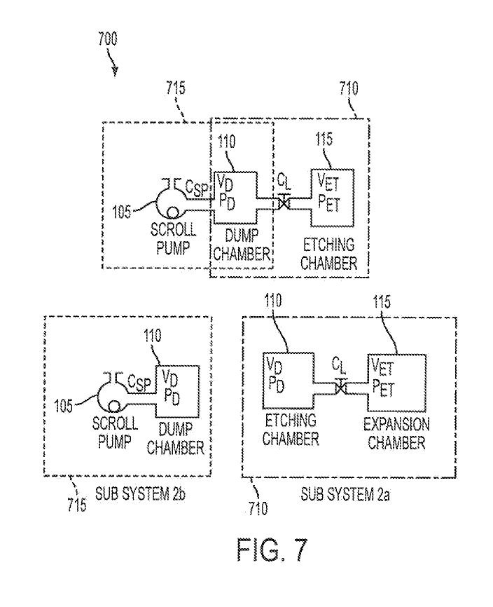

The sizing of the pump and dump tanks volume is now described. Subsystem 2 515 of FIG. 5 describes the set of conditions for the end of a single pulse, i.e. controls Δt_{finish}. Subsystem 2 515 can be further divided into two subsystems namely Subsystem 2a 710 and Subsystem 2b 715 as shown in FIG. 7.

Continuity for Subsystem 2 515 states that

$${V}_{etch} \frac{d {P}_{etch}}{d t} + {C}_{L} ( {P}_{etch} - {P}_{dump} ) = {V}_{dump} \frac{d {P}_{dump}}{d t} + {C}_{sp} ( {P}_{dump} - {P}_{ult} ) \qquad ( 11 )$$

where C_{L} and Cₛₚ are the conductance of the tubing connecting the etching chamber 115 to the dump chamber 110 and conductance of the scroll pump 105, respectively. Pᵤₗₜ is the ultimate base pressure of the scroll pump 105. Breaking Subsystem 2 515 into Subsystem 2a 710 and 2b 715 allows for a more intuitive interpretation and easier solution to Eqn. 11. For Subsystem 2a 710:

$$\begin{matrix}{P}_{dump} ( t ) = \frac{n RT}{( {V}_{dump} + {V}_{etch} )} + ( {P}_{initial - dump} - \frac{n RT}{( {V}_{dump} + {V}_{etch} )} ) {e}^{\frac{{C}_{L}}{2} ( \frac{1}{{V}_{dump}} + \frac{1}{{V}_{etch}} ) t} & ( 12 ) \\ {P}_{etch} ( t ) = \frac{n RT}{( {V}_{dump} + {V}_{etch} )} + ( {P}_{initial - etch} - \frac{n RT}{( {V}_{dump} + {V}_{etch} )} ) {e}^{\frac{{C}_{L}}{2} ( \frac{1}{{V}_{dump}} + \frac{1}{{V}_{etch}} ) t} & ( 13 )\end{matrix}$$

which follows from a similar analysis to arrive at Eqs. 8 and 9. The time constant for Subsystem 2a 710 is:

$${τ}_{2 a} = - \frac{2}{{C}_{L} ( \frac{1}{{V}_{dump}} + \frac{1}{{V}_{etch}} )} \qquad ( 14 )$$

For Subsystem 2b 715:

$${P}_{dump} ( t ) = {P}_{initial} {e}^{\frac{- 1}{( {V}_{dump} \text{/} {C}_{sp} )}} \qquad ( 15 )$$

and its time constant is:

$${τ}_{2 b} = \frac{{V}_{dump}}{{C}_{sp}} \qquad ( 16 )$$

Again, note that common etching times, Δtᵣₓₙ, in the literature commonly range between 30-60 sec. Making τ<0.3 sec ensures that for common conditions etching chamber's 115 pressure rise accounts for less than 1% of the overall etching time and therefore accounts for a negligible portion of the actual etching time. Decoupling the Subsystems 2a 710 and 2b 715 creates two systems of differential equations that are coupled together through V_{dump}. Varying the other parameters in the time constants, Eqs. 14 and 16, allows for a study of the effect of the time constants themselves.

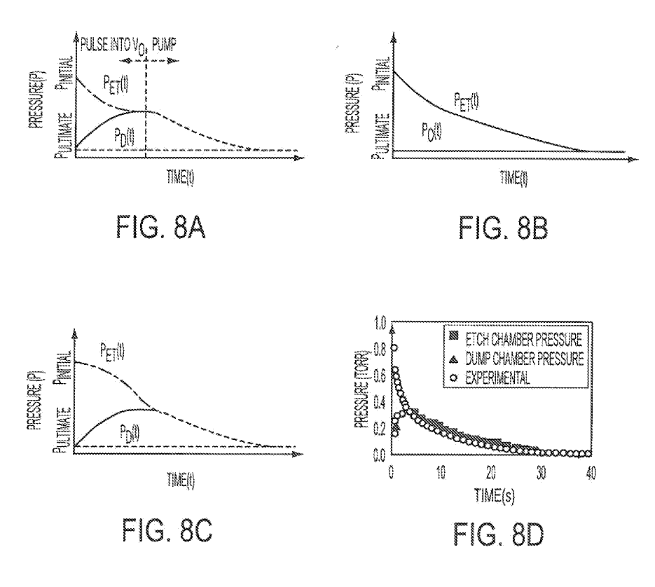

Three scenarios are possible: τ₂ₐ<<τ_{2b}, τ₂ₐ>>τ_{2b}, and τ₂ₐ˜τ_{2b}. When τ₂ₐ<21 τ_{2b}, the gas from the etching chamber 115 is dumping gas into the dump chamber 110 much faster than the scroll pump 105 can remove the gas from the dump chamber 110. Thus the pressures in the etching chamber 115 and the dump chamber 110 equilibrate relatively quickly and then reach the ultimate pressure in unison as in FIG. 8a. If τ₂ₐ>>τ_{2b}, then the pump is able to remove gas introduced into the dump chamber 110 just as fast as it can move into the dump chamber 110 from the etching chamber 115. Effectively, it is as if the dump chamber 110 was not present and the time to lower the pressure in the etch chamber 115 will be dictated be the speed of the scroll pump 105, FIG. 8b. This can also be the result of a choked flow due to C_{L} being too small. Finally, when τ₂ₐ˜τ_{2b}, the pumping speed, conductances, and the volume of the etching chamber 115 effect the speed at which the pressure will lower in the etching chamber 115. The pressure in the etching chamber 115 and the dump tank 110 will join quickly and then move together as in FIG. 8c.

Note that thus far the pumping speed for the pump, Cₛₚ, has been considered to be constant. In reality the pumping speed is a function of the differential pressure it encounters. The functionality of the pumping speed typically, takes the form of:

Cₛₚ=k₁ln(P)+k₂ (17)

where k₁ and k₂ are constants that are fit to a pump speed curve. Using this form for the conductance then the pressure in the dump chamber 110 from the perspective of Subsystem 2b 715 is:

$$\frac{d {P}_{dump}}{d t} = \frac{- {k}_{1} {P}_{dump}}{{V}_{dump}} ln ( {P}_{dump} ) + \frac{{k}_{1} {P}_{ult}}{{V}_{dump}} ln ( {P}_{dump} ) - \frac{{k}_{2} {P}_{dump}}{{V}_{dump}} {P}_{dump} + \frac{{k}_{2} {P}_{ult}}{{V}_{dump}} \qquad ( 18 )$$

Solution of Eqn. 18 is possible numerically. In order to have theory match experiments this methodology was used to generate FIG. 8d. Experimental results are shown in FIG. 8d for the case where τ₂ₐ˜τ_{2b}. The time constant for the system is 300 msec.

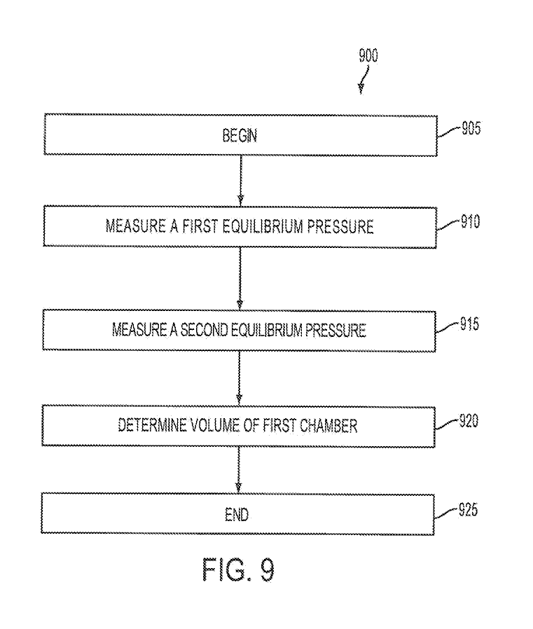

FIG. 9 shows an example method for determining a volume, at room temperature, of a first chamber having an unknown volume that is in fluid communication, through a controllable valve, with a second chamber having an unknown volume, according the present teachings. For example, the first chamber is an expansion chamber and the second chamber is an etching chamber of a pulsed XeF₂ etching system. The method begins at 905. For example, prior to the measuring the first equilibrium, a pressure of the first chamber can be reduced from a first initial pressure to a first intermediate pressure while the controllable valve is closed and the first chamber and the second chamber are isolated from each other. Subsequently, a pressure of the second chamber can be increased from a second initial pressure to a second intermediate pressure by introduction of the gas, wherein the first intermediate pressure is much less than the second intermediate pressure while the controllable valve is closed. The controllable valve separating the first chamber and the second chamber can then be opened such that the gas introduced into the second chamber is allowed to each equilibrium between the first chamber and the second chamber.

At 910, a pressure sensor, coupled to one of the first chamber and the second chamber, measures a first equilibrium pressure of a gas that was introduced into the second chamber in both the first chamber and the second chamber after equilibrium is reached. At 915, the pressure sensor measures a second equilibrium pressure of the gas that was introduced into the second chamber in both the first chamber and the second chamber after equilibrium is reached, wherein the first chamber comprises an object with a known volume therein. At 920, the volume of the first chamber is determined based on the first equilibrium pressure and the second equilibrium pressure. At 920, the method can end.

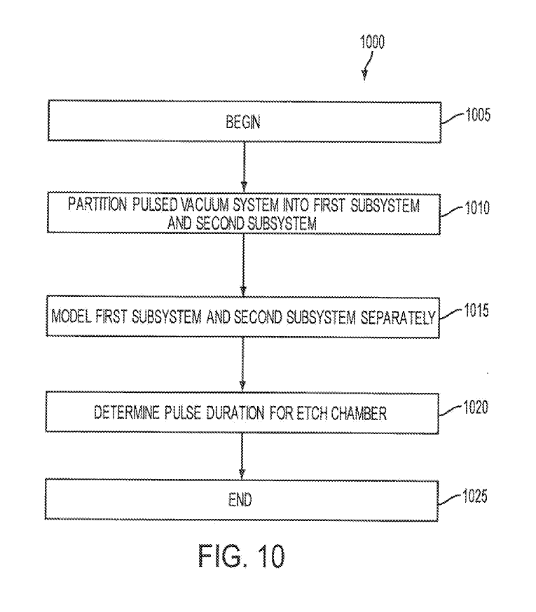

FIG. 10 shows an example method for modeling a pulse duration that a sample is etched in a pulsed vacuum system having a pump that is in controllable fluid communication with a dump chamber this is in controllable fluid communication with an etching chamber that is in controllable fluid communication with an expansion chamber, according to the present teachings. The method can begin at 1005. At 1010, the pulsed vacuum system can be partitioned into a first subsystem comprising the pump, the dump chamber, and the etching chamber and a second subsystem comprising the etching chamber and the expansion chamber. At 1015, the first subsystem and the second subsystem can be separately modeled using an energy balance technique. The first subsystem can also be further divided into a first sub-subsystem comprising the pump and the dump chamber and a second sub-subsystem comprising the dump chamber and the etching chamber. The first sub-subsystem and the second sub-subsystem can also be separately modeled using the energy balance technique. At 1020, the pulse duration can be determined to be used in the etching chamber based on the modeling. At 1025, the method can end.

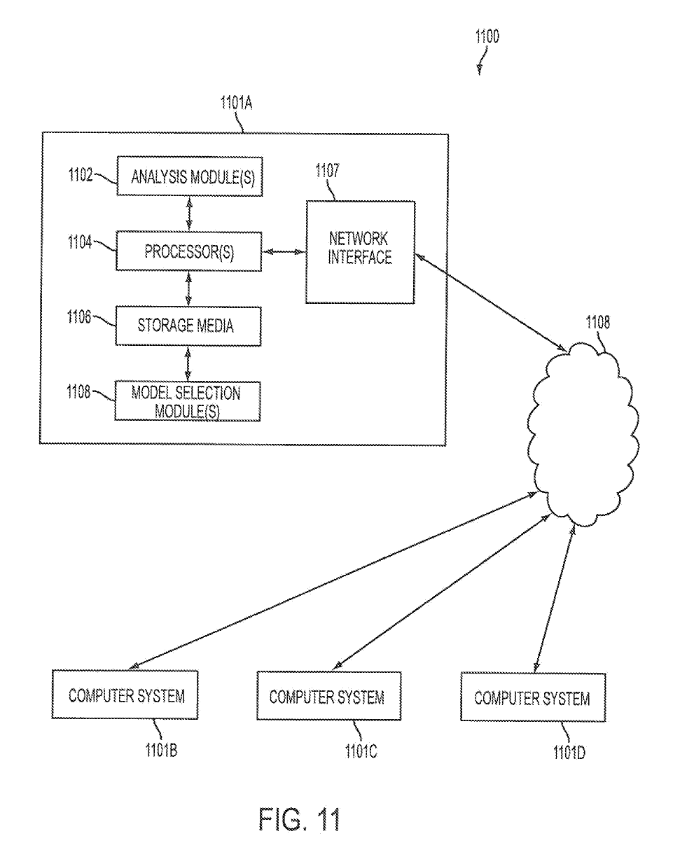

In some embodiments, the method 900, 1000 (and/or any of the processes thereof) may be executed by a computing system. FIG. 11 illustrates an example of such a computing system 1100, in accordance with some embodiments. The computing system 1100 may include a computer or computer system 601A, which may be an individual computer system 1101A or an arrangement of distributed computer systems. The computer system 1101A includes one or more analysis modules 1102 that are configured to perform various tasks according to some embodiments, such as one or more methods disclosed herein (e.g., method 900, 1000). To perform these various tasks, the analysis module 1102 executes independently, or in coordination with, one or more processors 1104, which is (or are) connected to one or more storage media 1106A. The processor(s) 1104 is (or are) also connected to a network interface 1107 to allow the computer system 1101A to communicate over a data network 1108 with one or more additional computer systems and/or computing systems, such as 11016, 1101C, and/or 1101D (note that computer systems 11016, 1101C and/or 1101D may or may not share the same architecture as computer system 601A, and may be located in different physical locations, e.g., computer systems 1101A and 11016 may be located in a processing facility, while in communication with one or more computer systems such as 1101C and/or 1101D that are located in one or more data centers, and/or located in varying countries on different continents).

A processor may include a microprocessor, microcontroller, processor module or subsystem, programmable integrated circuit, programmable gate array, or another control or computing device.

The storage media 1106A may be implemented as one or more computer-readable or machine-readable storage media. Note that while in the example embodiment of FIG. 11 storage media 1106A is depicted as within computer system 1101A, in some embodiments, storage media 1106A may be distributed within and/or across multiple internal and/or external enclosures of computing system 1101A and/or additional computing systems. Storage media 1106A may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY® disks, or other types of optical storage, or other types of storage devices. Note that the instructions discussed above may be provided on one computer-readable or machine-readable storage medium, or alternatively, may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1100 contains one or more model selection module(s) 1108. In the example of computing system 1100, computer system 1101A includes model selection module 1108. In some embodiments, a single model selection module may be used to perform some or all aspects of one or more embodiments of the method 900, 1000. In alternate embodiments, a plurality of model selection modules may be used to perform some or all aspects of method 900, 1000.

It should be appreciated that computing system 1100 is only one example of a computing system, and that computing system 1100 may have more or fewer components than shown, may combine additional components not depicted in the example embodiment of FIG. 11, and/or computing system 1100 may have a different configuration or arrangement of the components depicted in FIG. 11. The various components shown in FIG. 6 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention. The steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques

Mathematical models were provided herein around design considerations for pulsed vacuum systems, including the control of the chamber pressure and pulse duration. Allowing a known pressure and volume of gas to move between two chambers can be used to accurately control chamber pressure. Pressure sensors can provide the exact pressure; however, knowledge of the exact volumes can be difficult to determine. As such, a method was provided for accurate determination of chamber volume that involves the introduction of a calibrated volume into a chamber. By varying chambers' volumes, configurations, pressures, and the conductances between the chambers the pulse duration is accurately controlled.

It is noted that, as used in this specification, the singular forms “a,” “an,” and “the,” include plural referents unless expressly and unequivocally limited to one referent. Thus, for example, reference to “a chamber” includes two or more different chambers. As used herein, the term “include” and its grammatical variants are intended to be nonlimiting, such that recitation of items in a list is not to the exclusion of other like items that can be substituted or other items that can be added to the listed items.

Upon studying the disclosure, it will be apparent to those skilled in the art that various modifications and variations can be made in the devices and methods of various embodiments of the invention. Other embodiments will be apparent to those skilled in the art from consideration of the specification and practice of the embodiments disclosed herein. It is intended that the specification and examples be considered as examples only. The various embodiments are not necessarily mutually exclusive, as some embodiments can be combined with one or more other embodiments to form new embodiments.

What is claimed:

1. A method for determining a volume, at room temperature, of a first chamber having an unknown volume that is in fluid communication through a controllable valve with a second chamber having an unknown volume, the method comprising:
measuring, by a pressure sensor coupled to one of the first chamber and the second chamber, a first equilibrium pressure of a gas that was introduced into the second chamber in both the first chamber and the second chamber after equilibrium is reached;
measuring, by the pressure sensor, a second equilibrium pressure of the gas that was introduced into the second chamber in both the first chamber and the second chamber after equilibrium is reached, wherein the first chamber comprises an object with a known volume therein; and
determining, by a processor, the volume of the first chamber based on the first equilibrium pressure and the second equilibrium pressure.

2. The method according to claim 1, wherein prior to the measuring the first equilibrium, the method further comprises:
reducing a pressure of the first chamber from a first initial pressure to a first intermediate pressure while the controllable valve is closed and the first chamber and the second chamber are isolated from each other.

3. The method according to claim 2, further comprising:
increasing a pressure of the second chamber from a second initial pressure to a second intermediate pressure by introduction of the gas, wherein the first intermediate pressure is much less than the second intermediate pressure while the controllable valve is closed.

4. The method according to claim 3, further comprising:
opening the controllable valve separating the first chamber and the second chamber such that the gas introduced into the second chamber is allowed to each equilibrium between the first chamber and the second chamber.

5. The method according to claim 1, wherein the first chamber is an expansion chamber and the second chamber is an etching chamber of a pulsed XeF₂ etching system.

6. The method according to claim 1, wherein the first chamber is an etching chamber and the second chamber is an expansion chamber of a pulsed XeF₂ etching system.

7. A method for modeling a pulse duration that a sample is etched in a pulsed vacuum system having a pump that is in controllable fluid communication with a dump chamber this is in controllable fluid communication with an etching chamber that is in controllable fluid communication with an expansion chamber, the method comprising:
partitioning the pulsed vacuum system into a first subsystem comprising the pump, the dump chamber, and the etching chamber and a second subsystem comprising the etching chamber and the expansion chamber;
separately modeling the first subsystem and the second subsystem using an energy balance technique; and
determining, by a processor, the pulse duration to be used in the etching chamber based on the modeling.

8. The method according to claim 7, further comprising:
partitioning the first subsystem into a first sub-subsystem comprising the pump and the dump chamber and a second sub-subsystem comprising the dump chamber and the etching chamber; and
separately modeling the first sub-subsystem and the second sub-subsystem using the energy balance technique.

9. The method according to claim 7, wherein the energy balance technique comprises applying the Ideal Gas Law to each chamber of the pulsed vacuum system.

10. A system for modeling a pulse duration that a sample is etched in a pulsed vacuum system having a pump that is in controllable fluid communication with a dump chamber this is in controllable fluid communication with an etching chamber that is in controllable fluid communication with an expansion chamber, the system comprising:
one or more memory devices storing instructions; and
one or more processors coupled to the one or more memory devices and configured to execute the instructions, the one or more processors to:
partition the pulsed vacuum system into a first subsystem comprising the pump, the dump chamber, and the etching chamber and a second subsystem comprising the etching chamber and the expansion chamber;
separately model the first subsystem and the second subsystem using an energy balance technique; and
determine the pulse duration to be used in the etching chamber based on the modeling.

11. The system according to claim 10, wherein the one or more processors further execute the instructions to:
partition the first subsystem into a first sub-subsystem comprising the pump and the dump chamber and a second sub-subsystem comprising the dump chamber and the etching chamber; and
separately model the first sub-subsystem and the second sub-subsystem using the energy balance technique.

12. The system according to claim 10, wherein the energy balance technique comprises applying the Ideal Gas Law to each chamber of the pulsed vacuum system.

13. A non-transitory computer-readable storage medium having instructions which, when executed on a processor, perform a method for modeling a pulse duration that a sample is etched in a pulsed vacuum system having a pump that is in controllable fluid communication with a dump chamber this is in controllable fluid communication with an etching chamber that is in controllable fluid communication with an expansion chamber, the method comprising:
partitioning the pulsed vacuum system into a first subsystem comprising the pump, the dump chamber, and the etching chamber and a second subsystem comprising the etching chamber and the expansion chamber;
separately modeling the first subsystem and the second subsystem using an energy balance technique; and
determining, by a processor, the pulse duration to be used in the etching chamber based on the modeling.

14. The non-transitory computer-readable storage medium according to claim 13, further comprising:
partitioning the first subsystem into a first sub-subsystem comprising the pump and the dump chamber and a second sub-subsystem comprising the dump chamber and the etching chamber; and
separately modeling the first sub-subsystem and the second sub-subsystem using the energy balance technique.

15. The non-transitory computer-readable storage medium according to claim 13, wherein the energy balance technique comprises applying the Ideal Gas Law to each chamber of the pulsed vacuum system.
